(19) United States
(12) Patent Application Publication
(10) Pub. No.: US 2014/0308634 A1
(43) Pub. Date: Oct. 16, 2014

(54) METHOD AND SYSTEM FOR ACTUALIZING PROGRESSIVE LEARNING

(71) Applicant: TATA CONSULTANCY SERVICES LIMITED, Mumbai (IN)

(72) Inventors: Pratik Kumar Mishra, Chennai (IN); Dinesh Pothineni, Chennai (IN); Aadil Rasheed, Chennai (IN)

(73) Assignee: Tata Consultancy Services Limited, Mumbai (IN)

(21) Appl. No.: 13/861,279

(22) Filed: Apr. 11, 2013

(51) Int. Cl. G09B 19/00

(52) U.S. Cl. CPC G09B 19/00
USPC 434/236

(57) ABSTRACT

Disclosed herein is a web-based learning apparatus and a method for progressive learning. The apparatus and a method enables identifying a learning flow pattern of the user for a particular topic by mapping the synchronicity of events with interest graphs in similarity sets. Further, the shift in user learning pattern and interest graph is recorded to enable the system derive an updated learning matrix of the user that is capable of presenting and recommending to the user of new expanded matrix comprising topics of his evolving interest.

### TECHNICAL FIELD

The present disclosure described herein, in general, relates to web-based e-learning, and more particularly to a web-enabled model based on Rhizomatic learning and contextual relations generated from similarity sets of social networks.

### BACKGROUND

Social networks have a newfound impact on personal learning and behavior of a person based on his social connections. Sociologists have identified two major factors, selection and social influence, as root causes of this impact. People are naturally inclined towards (i.e., select) other people with similar interests, hobbies and like similarities and often tend to form connections with them. The interactions between these people gradually increase due to the presence of social influence on one another. The activity of people on the social networks constantly drives social systems towards uniform behavior of these people, which can be observed in social networks.

Intellectual learning systems help students achieve precise learning goals. Traditional systems use an automated teaching approach that mirrors the approach taken in brick-and-mortar classrooms. Each student is presented with the same learning contents like lecture, and assessment, regardless of learning style, intelligence, or cognitive characteristics.

Another approach in such systems is considering the influence of interactions on a student's cognitive process, like the behavior of the person on a social network. Networked learning is built around learning communities and interactions, to extend the access of knowledge beyond the traditional limitations of local communities or domains. Learning methods are becoming social, to involve more people and to spark meaningful conversations between similar sets.

Rhizomatic Learning involves the behavioral aspects of collaborative learning. This is a theory of learning built on the concept of dynamic networks formed due to the social network and its interaction Rhizomatic learning is a unique model, where experts don't guide the curriculum with their inputs; rather, it is discussed and built by the people involved in the learning process in real-time. Rhizomatic learning can lead to build a flexible education model, one that can adapt to dynamic changes of knowledge, and rewire with the emerging relations on social network.

### SUMMARY

This summary is provided to introduce aspects related to methods and systems for web-based learning wherein such aspects are further described below in the detailed description. This summary is not intended to identify essential features of the claimed subject matter nor is it intended for use in determining or limiting the scope of the claimed subject matter.

In one implementation, user learning information is inferred based on the learning information acquired from one or more social networking environment. The user learning information may be mapped against that of the other users for deriving one or more similar set of users. The set of users exhibit similarity in at least one of the user learning information. The one or more similar set of users is iteratively assessed for estimating a learning shift. At least one dynamically updated learning matrix may be derived from aforementioned steps of mapping and assessing. The learning matrix may be representative of the similar set of users, or their learning shift, or a combination thereof. The similar set of users can be grouped based on the inferred user learning information and the learning shift for eventually assessing dissimilarity among said similar sets. For the users, otherwise exhibiting the dissimilarity, but identified of exhibiting similarity in the at least one of the user learning information of the learning matrix, back-titration is performed thereon to accommodate one or more newly identified information in the learning matrix which eventually results in an expanded learning matrix. The expanded learning matrix can then be presented upon a user interface.

In another implementation, data acquisition logic may be configured to acquire and infer user learning information from one or more social networking environment. Further analysis logic may be configured to map the user learning information. The user learning information can be mapped against one or more other users to determine similar set of users exhibiting similarity in the at least one of user learning information. The user can be iteratively assessed for estimating learning shift. Further, dissimilarity can be evaluated among the similar set of users. A learning matrix logic can then be configured to construct at least one dynamically updated learning matrix. The learning matrix can be representative of the similar set of users, or the learning shift, or a combination thereof. In response to mapping and assessment by the analysis logic, the users otherwise exhibiting the dissimilarity, so identified of exhibiting similarity in the at least one of the user learning information, the system performs back-titration to accommodate one or more newly identified information in the learning matrix that results in an expanded learning matrix. Further, presentation logic may be configured to present the expanded learning matrix.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a system for web-based learning apparatus in accordance with an embodiment of the present subject matter.

FIG. 2 depicts a web learning apparatus illustrated in accordance with an embodiment of the present subject matter.

FIG. 3 is a flowchart illustrating a method for transmitting web-based learning, in accordance with an embodiment of the present subject matter.

### DETAILED DESCRIPTION

A system and method for web-based learning apparatus is disclosed. The present subject matter enables mapping of interests and activities of an individual with other users of web-based learning platform.

Specifically, the disclosure may enable the system to keep a track of a learning behavior of users. The learning behavior of a user may be captured based on the subjective analysis of the activities performed by the user. The subjective analysis may be performed with respect to another individual. A set of derived interest, activities, interest and interaction of the user may be captured and mapped with respect to another individual; the set thus serves as a primary input for social learning, which may be captured by the web-based learning platform. The web-based learning apparatus may provide a holistic approach of how factors can affect the learning behavior.

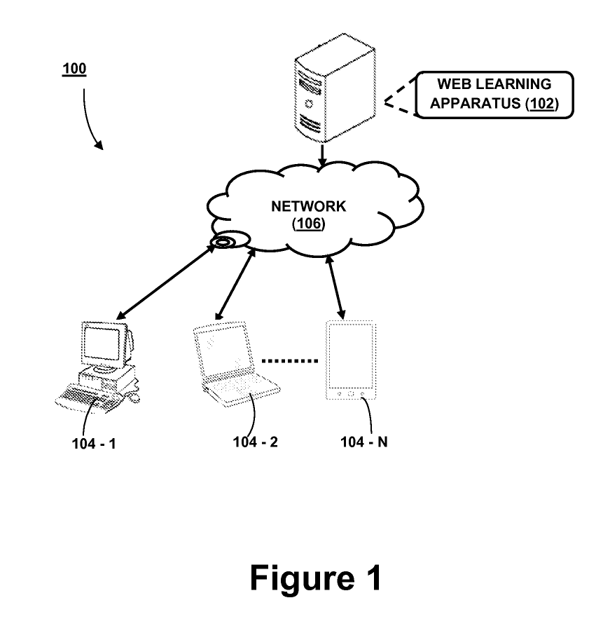

Referring now to FIG. 1, a system 100 for web-based learning apparatus is presented. The system for web-based learning apparatus comprises a web learning apparatus 102, wherein the web learning apparatus may be implemented upon a variety of computing systems, such as a laptop computer, a desktop computer, a notebook, a workstation, a mainframe computer, a server, a network server, and the like. It will be understood that the web learning apparatus 102 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the web learning apparatus 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

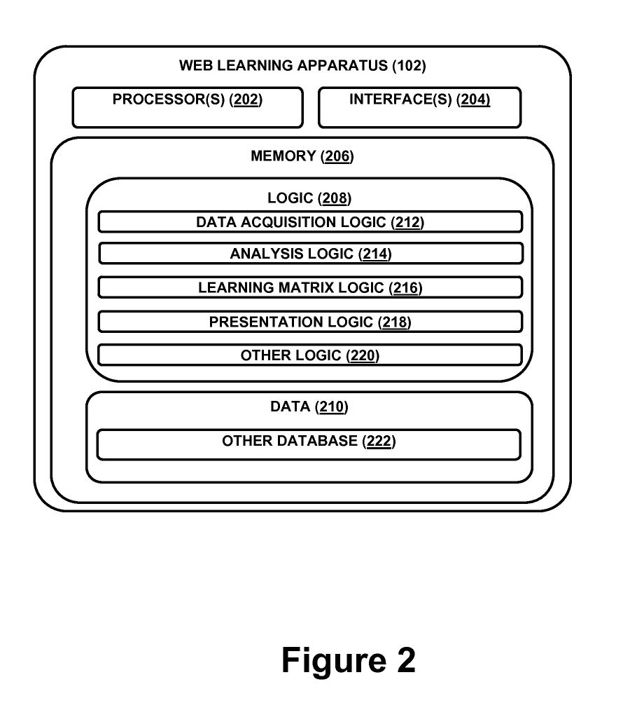

Referring now to FIG. 2, the web learning apparatus 102 is illustrated in accordance with an embodiment of the present subject matter. In one embodiment, the web learning apparatus 102 may include a processor 202, an input/output (I/O) interface 204, and a memory 206. The first processor 202 may be implemented as one or more microprocessors, microcomputers, microcontrollers, digital signal processors, central processing units, state machines, logic circuitries, and/or any devices that manipulate signals based on operational instructions. Among other capabilities, the processor 202 may be configured to fetch and execute computer-readable instructions stored in the memory 206.

The I/O interface 204 may include a variety of software and hardware interfaces, for example, a web interface, a graphical user interface, and the like. The I/O interface 204 may allow the web learning apparatus 102 to interact with a user directly or through the client devices 104. The I/O interface 204 may further enable the broadcaster 102 to communicate with other computing devices, such as web servers or external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory like static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include logic 208 and data 210. The logic 208 may include routines, programs, objects, components, data structures, etc., which perform particular tasks or implement particular abstract data types. In one implementation, the logic 208 may include data acquisition logic 212, analysis logic 214, learning matrix logic 216, presentation logic 218 and other logic 220. The other logic 220 may include programs or coded instructions that supplement applications and functions of the web learning apparatus 102.

The data 210, amongst other things, may serve as a repository for storing data processed, received, and generated by one or more of the logic 208. The data 210 may also include other database 222. The other database 222 may include data generated as a result of the execution of one or more modules in the other logic 220.

In one embodiment, the data acquisition logic 212 of the web learning apparatus 102 may acquire user-learning information from one or more social networking environment like Twitter™ or Google Plus™. The data acquisition logic 212 may further be configured to derive and infer the users learning information from one or more social networking. For the purposes of present disclosure, the data acquisition logic 212 may be enabled to acquire and draw inference from the data acquired from afore-mentioned social networks using techniques well known and acknowledged by person having ordinary skill in the art.

The analysis logic 214 according to an embodiment may be configured to map the users learning information acquired, against one or more other users to determine similar set of users. The analysis logic 214 may further be configured to assess the user iteratively for estimating learning shift and evaluate dissimilarity among the similar set of users. For example: when the user encounters interesting information, a shift may be experienced in the learning curve pertaining to the user that necessitates re-mapping of the user with the new acquired information. A topic shift matrix may then be created for all the users having acquired changes for similarity of topics above a preset threshold. A unique threshold limit may be associated with each of the topic shift matrix. A Jaccard coefficient may be computed for each of the topic shift matrix.

According to an embodiment, the Jaccard coefficient may be iteratively computed for every user, enabling the web learning apparatus 102 to reflect users with a very high profile similarity. The computation of Jaccard coefficient may be used to deduce a synchronicity matrix. Jaccard coefficient may be an efficient way to identify these similarity and diversity between sets.

Jaccard similarity coefficient=Size of intersection/Size of union

This value may be calculated for all the pairs in the group to fill the matrix with similarity coefficient against interest groups. Jaccard distance may provide the desired output of dissimilarity between groups. It may motivate the user towards new learning curves and diversifying the interest graph.

$$\text{?} ( A , B ) = 1 - J ( A , B ) = \frac{\vert A ⋃ B \vert - \vert A ⋂ B \vert}{\vert A ⋃ B \vert} \text{?}$$

$$T ( A , B ) = \frac{A \cdot B}{{‖ A ‖}^{2} + {‖ B ‖}^{2} - A \cdot B}$$

$$\text{?} \text{indicates text missing or illegible when filed}$$

Wherein, “A” represents a set of users having interest in a particular topic, say for Topic A. Similarly, “B” represents a set of users having interest in another particular topic, say for example Topic B similarity, across which the present disclosure teaches to compute dissimilarity.

However, the above set complement may not be applied in general when the subject becomes uni-dimensional vector with a value of 0 or 1.

The synchronicity matrix may enable representation of events or topic, that lead to the interaction of the user, wherein under normal circumstance the interaction of the user with the other user would not have been possible. According to an embodiment, the synchronicity matrix may be derived using Sorensen index. The Sorensen index may enable calculation of the similarity coefficient.

The learning matrix logic 216 may be configured to construct at least one dynamically updated learning matrix representative of the similar set of users, or the learning shift, or a combination thereof. The learning matrix for the users with similar interest may have a common weightage assigned at their interaction points. According to an embodiment, merging the synchronicity matrix with a weighted list of recommended topics may generate the learning matrix for the topic of the user. The list of recommended topics can be derived by summing the weights of the individual topics from all the other users sharing similarity with the user.

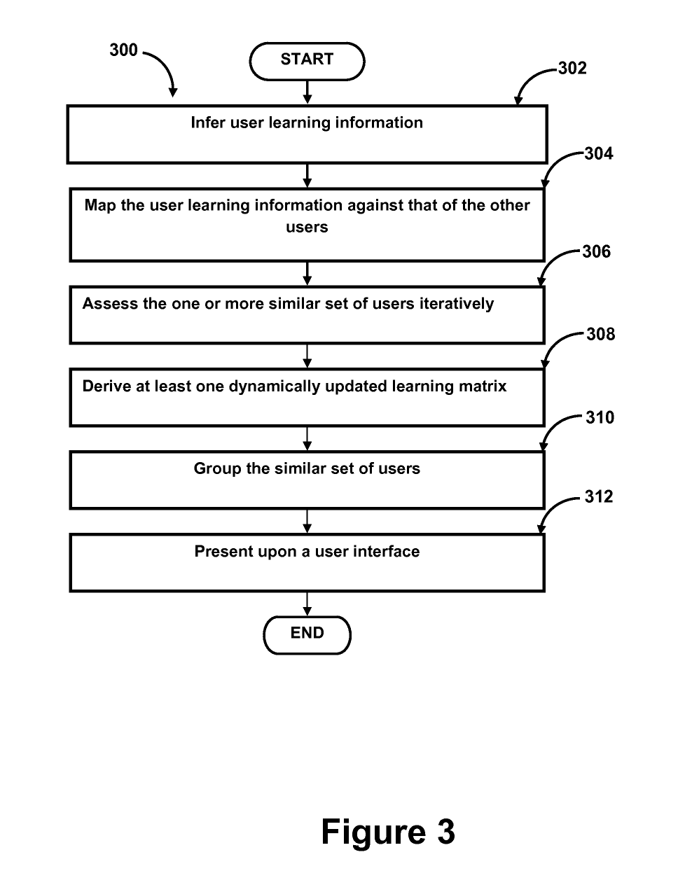

Referring now to FIG. 3, provided is a flowchart illustrating a method for web-based learning, in accordance with an embodiment of the present subject matter. The order in which the method 300 is described is not intended as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented in the above-described web-based learning apparatus 102.

At block 302, based upon the data acquired pertaining to the user from various social networking platforms, learning information for the user may be inferred. The learning information may comprise one or more topics of interest to the user. The learning information may also comprise of new topics of interest to the user. Based on the data acquired, interest graph may be created that represent learning behavior of the user.

At block 304, the learning information of the user may be mapped with other users. The mapping may also be done based on the interest graph created for the user with the interest graph of the other user. A set of user having similarity to the user can be created. At block 306, the user may be assessed with one or more similar set of users iteratively for estimating a learning shift. The user when exposed to new learning information may experience new learning behavior, which may be captured by way of the interest graph. The interest graph can be re-mapped and assessed with the similar set of user. A topic-shift matrix may be created based on the interest graphs that may be re-mapped for the user against each user from the set of users. The topic-shift matrix may comprise user mapped with topic similarity over a preset threshold. Each topic-shift matrix has a unique threshold limit, as the composition of each matrix may be a contemporary composition of similar set of users. The similarity and diversity for each topic shift matrix may be computed using a Jaccard coefficient. Topic matrix with highest distance among the similar sets may be identified with a degree of confidence to map user to a new set with a different threshold to act as a seed source for flow suggestions and serendipity. Topic shift matrix reflecting high profile of similarity may be used to deduce a synchronicity matrix.

The synchronicity matrix may represent topics that lead to intersection of topics, which under normal circumstance would not have interacted or intersected. The synchronicity matrix may be based on fuzzy calculation of Sorensen index using a Sorensen method. The Sorenson method may involve following calculations:

$$QS = \frac{2 C}{A + B} = \frac{2 n ( A ⋂ B )}{n ( A ) + n ( B )}$$

Where QS is the similarity coefficient of topics A and B, and C is the common pattern shared by both topics along with their individual access patterns. Sorensen coefficient places the similarity in the range of [0, 1].

The combination of the synchronicity matrix with the topic shift matrix may derive a set of relevant and undiscovered topics for the user. For example, user with diverse interest may end up at the same topic through different routes. Though these routes may be different they may add information to user's interest graph. The synchronicity matrix according to an embodiment may backtrack to access pattern until a point where the topic shift matrix had experienced a shift. The synchronicity matrix may look for such collisions of learning to occur and all the corresponding partial topic shifts may be recorded.

Each matrix may be a representation of events/topics that lead to this particular collision. This may be based on multiple sources and needs a fuzzy calculation. Thus, Sorensen index may be employed to compute such collision and may be capable of distributing the load to both the sets of users in comparison and identifying the distance range of the outcome. Its ability to ignore or least regard the weight of outliers without losing sensitivity for heterogeneous data makes Sorensen method a favorable one, though not the only method that may be used, in the current scenario. According to an embodiment, combining the synchronicity matrix with topic shift matrix may reveal the relevant set of topics earlier undiscovered.

At block 308, a learning matrix may be derived. The learning matrix may enable to map the user with a new set of user with similar flow pattern pertaining to the learning information. The learning matrix according to an embodiment may build an extensive profile of the user based upon the social networking. Further, the learning matrix may capture indirectly a diffusion pattern of social interaction for the user with interest set outside the social network of the user. The learning matrix may enable discovery of a new set of users, which can be compared to the shifted user.

The learning matrix may enable derivation of a similarity matrix according to an embodiment wherein the similarity matrix is a function of shared interest of the user with another user irrespective of their social connection. This interest may, however, not be complementary between users. In the similarity matrix the user may have a higher similarity ratio to another and may have a very low value in return based on the exploration pattern of both the users.

S_{A}=f|X₁,X₂ . . . X_{N} where, T_{A}∩T_{X}≧θ.n(A), Xε(U−A)

S_{A}=Similarity ratio for user

T_{A}=Topic explored by the user

X=other users in system excluding user

T_{X}=Topic explored by another user

θ=Confidence variable

The Similarity score S(A) may be calculated with all the users, to find the topics that are explored by the users with a similarity score with higher confidence. Individuals with relatively common interest may share the same learning matrix at some point. They may be given common weightage throughout the events, wherever their interest graph is correlated. Shortlisted individuals who are already a part of users' social graph may be weighted, as synchronicity factor is naturally close.

User's current associated topics when removed from the established topic-shift matrix, generates a list of recommended topics. Sorting this by weightage and merging the resultant with the synchronicity matrix provides learning matrix for the user. Individual topics may be selected and their accumulated weights may be derived by the summation of the weights from all the users in the similarity filtered List. This new list when sorted by the weights of the topic provides the best topic user might want to check out, which would be easy to learn given the background and his learning matrix. This further result in expanding of the learning subset instead of narrowing it down.

At block 310, the set of user with similar interest may be grouped together and at block 312 may be represented in graphical form comprising expanded graph or matrix.

1. A web-based learning method comprising steps of:
inferring user learning information acquired from one or more social networking environment;
mapping the user learning information against that of other users for deriving one or more similar set of users exhibiting similarity in at least one of the user learning information;
assessing the one or more similar set of users iteratively for estimating a learning shift;
deriving at least one dynamically updated learning matrix representative of: the similar set of users, or the learning shift associated with the users, or a combination thereof;
grouping the similar set of users based on the user learning information and the learning shift, for assessing dissimilarity among said similar sets;
generating an expanded learning matrix using the dissimilarity among said similar sets, by performing back-titration on the at least one learning matrix to accommodate one or more newly identified information in the at least one learning matrix; and
presenting, upon a user interface, the expanded learning matrix, wherein at least one of the inferring, the mapping, the assessing, the deriving, the grouping and the presenting is performed by a processor.

2. The web-based learning method of claim 1, wherein the user learning information comprises at least one of a profile of the user along with at least one topic of-interest thereof, and user social interaction information.

3. The web-based learning method of claim 1, wherein the user learning information is inferred by an interest graph wherein said interest graph derives learning behavior curve of the user therefrom.

4. The web-based learning method of claim 1, wherein the learning shift is reflected as a shift in the learning behavior curve of the interest graph.

5. The web-based learning method of claim 1, wherein the learning shift is determined by way of assessing the user for any duration expended, on a topic not previously inferred as the topic of-interest, above a preset threshold limit.

6. The web-based learning method of claim 1, wherein each one of the at least one learning matrix is associated with a unique threshold limit for each incoming set of similar users.

7. The web-based learning method of claim 1, wherein the similarity or dissimilarity between the users are derived from Jaccard coefficient.

8. The web-based learning method of claim 1, wherein the back-titration is performed using Sorensen index.

9. The web-based learning method of claim 1, further comprising according weights to the topics of-interest contained within the expanded learning matrix to present upon the user interface the weighted topics in an ordered sequence of their interest.

10. A web-based learning apparatus comprising:
a processor;
a memory coupled to the processor, wherein the processor is configured to execute a plurality of logics embodied upon the memory, and wherein the plurality of logics comprising:
a data acquisition logic configured to acquire and infer user learning information for a user from one or more social networking environment;
an analysis logic configured to:
map said user learning information, acquired from the data acquisition and analysis logic, against one or more other users to determine a similar set of users exhibiting similarity in the at least one of user learning information;
assess the user iteratively for estimating learning shift; and
evaluate dissimilarity among said similar set of users;
a learning matrix logic configured to construct at least one dynamically updated learning matrix representative of the similar set of users, or the learning shift, or a combination thereof, upon interacting with the analysis logic;
wherein, in response to mapping and assessment by the analysis logic, for the similar set of users exhibiting the dissimilarity, the learning matrix performs back-titration to accommodate one or more newly identified information in the learning matrix, to result in an expanded learning matrix; and
a presentation logic configured to present the expanded learning matrix.

11. The web-based learning apparatus of claim 10, wherein the data acquisition logic acquires the user learning information comprising of a profile of the user along with at least one topic of-interest thereof, and user social interaction information.

12. The web-based learning apparatus of claim 10, wherein the analysis logic estimates the learning shift by way of assessing the user for any duration expended, on a topic not previously inferred as the topic of-interest, above a preset threshold limit.

13. The web-based learning apparatus of claim 10, wherein the analysis logic determines the similarity or dissimilarity between the users from Jaccard coefficient.

14. The web-based learning apparatus of claim 10, the learning matrix logic performs the back-titration using Sorensen index.

15. The web-based learning apparatus of claim 10, further comprising a weight assigning logic configured to assign weights to the topics of-interest contained within the expanded learning matrix, to coordinate with the presentation logic and present thereupon, the weighted topics in an ordered sequence of their interest.

16. A computer program product comprising program code stored on a computer readable medium for performing the method, comprising steps of:
inferring user learning information acquired from one or more social networking environment;
mapping the user learning information against that of other users for deriving one or more similar set of users exhibiting similarity in at least one of the user learning information;
assessing the one or more similar set of users iteratively for estimating a learning shift;
deriving at least one dynamically updated learning matrix representative of: the similar set of users, or the learning shift, or a combination thereof;
grouping the similar set of users based on the user learning information and the learning shift, for assessing dissimilarity among said similar sets;
generating an expanded learning matrix using the dissimilarity among said similar sets, by performing back-titration on the at least one learning matrix to accommodate one or more newly identified information in the at least one learning matrix; and
presenting, upon a user interface, the expanded learning matrix.
